(19) United States
(12) Patent Application Publication
(10) Pub. No.: US 2016/0093260 A1
(43) Pub. Date: Mar. 31, 2016

(54) DISPLAY DEVICE AND ASSOCIATED METHOD

(71) Applicant: Innolux Corporation, Chu-Nan (TW)

(72) Inventor: Hirofumi WATSUDA, Chu-Nan (TW)

(73) Assignee: INNOLUX CORPORATION, Chu-Nan (TW)

(21) Appl. No.: 14/583,458

(22) Filed: Dec. 26, 2014

Related U.S. Application Data
(60) Provisional application No. 62/056,654, filed on Sep. 29, 2014.

(51) Int. Cl. G09G 3/36

(52) U.S. Cl. CPC G09G 3/3648; G09G 2310/0297; G09G 2310/08

(57) ABSTRACT

A display device comprises a display panel. The display panel comprises a plurality of gate lines, a plurality of data lines, a plurality of sub-pixels, a gate driver connected to the gate lines, and a data driver connected to the data lines. The data driver comprises a de-multiplexer controller for outputting a plurality of control signals to a plurality of control lines, a data process portion for outputting a plurality of data signals to a plurality of signal lines, and a first de-multiplexer comprising a plurality of switches connected to the de-multiplexer controller through the control lines, the data process portion through at least one of the signal lines, and the sub-pixels through the data lines. Wherein the switches of the first de-multiplexer keep turned on within a first horizontal period.

This application claims the benefit of U.S. provisional patent application No. 62/056,654, filed Sep. 29, 2014, the disclosure of which is incorporated by reference herein in its entirety.

### BACKGROUND

1. Technical Field

The disclosure relates in general to a display device and associated method, and more particularly to a display device and associated method capable of saving power consumption.

2. Description of the Related Art

In recent years, all the display devices are developed toward thin and light weight. Liquid crystal display (hereinafter, LCD) device and organic light emitting diode (hereinafter, OLED) device are gradually developed to meet the requirement. The LCD and OLED can be applied to various fields. For example, daily used devices such as cell phones, notebooks, video cameras, cameras, music players, navigation devices, and televisions are equipped with display panels. In a display device, data process portion of data driver comprises several de-multiplexers (hereinafter, DEMUX). With the DEMUXes, pin number of driver IC chip signal output can be reduced, and number of served data lines can be increased. While displaying a frame image, all switches of the de-multiplexer are required to be turned on and turned off asynchronously for individually transmitting data signals to the significant number of sub-pixels in different columns. Such asynchronously turn on and turn off operations result in dramatic power consumption.

Nowadays, majority of the portable devices are equipped with display panels and power consumption of portable devices is a critical issue. Hence, lowering power consumption of the display device is important.

### SUMMARY

The disclosure is directed to a display device and associated method.

According to one embodiment, a display device including a display panel, a gate driver, and a data driver is provided. The display panel includes a plurality of gate lines, a plurality of data lines, and a plurality of sub-pixels. The gate driver is connected to the gate lines, and the data driver is connected to the data lines. The data driver includes a de-multiplexer controller, a data process portion, and a first de-multiplexer. The de-multiplexer controller outputs a plurality of control signals to a plurality of control lines. The data process portion outputs a plurality of data signals to a plurality of signal lines. The first de-multiplexer includes a plurality of switches. The first de-multiplexer is connected to the de-multiplexer controller through the control lines, connected to the data process portion through at least one of the signal lines, and connected to the sub-pixels through the data lines. The switches of the first de-multiplexer keep turned on within a first horizontal period.

According to another embodiment, a method associated to a display device is provided. The method is used for driving the display device. The display device includes a display panel, a gate driver, and a data driver. The display panel includes a plurality of gate lines, a plurality of data lines, and a plurality of sub-pixels. The gate driver is connected to the gate lines, and the data driver is connected to the data lines. The data driver includes a de-multiplexer controller, a data process portion, and a first de-multiplexer. The de-multiplexer controller outputs a plurality of control signals to a plurality of control lines. The data process portion outputs a plurality of data signals to a plurality of signal lines. The first de-multiplexer includes a plurality of switches. The first de-multiplexer is connected to the de-multiplexer controller through the control lines, connected to the data process portion through at least one of the signal lines, and connected to the sub-pixels through the data lines. The switches of the first de-multiplexer keep turned on within a first horizontal period.

### BRIEF DESCRIPTION OF THE DRAWINGS

FIG. 1 is a schematic view showing the configuration of a display device.

FIG. 2A is a schematic diagram illustrating configuration of a de-multiplexer portion connected to a display panel.

FIG. 2B is a schematic diagram illustrating timing of the control signals and the data signals for the de-multiplexer shown in FIG. 2A.

FIG. 3 is a schematic diagram illustrating timing of the control signals and the data signals for the de-multiplexers shown in FIG. 2A according to a concept of the present invention.

FIG. 4A is a schematic diagram illustrating a portrait mode display device.

FIG. 4B is a schematic diagram illustrating timing of the control signals and the data signals for the display panel in FIG. 4A.

FIG. 5A is a schematic diagram illustrating a display panel for displaying an interlaced frame image.

FIG. 5B is a schematic diagram illustrating timing of the control signals and the data signals for the display panel in FIG. 5A.

FIG. 6A is a schematic diagram illustrating the transflective display device is in transmissive mode.

FIG. 6B is a schematic diagram illustrating timing of the control signals and the data signals for the display panel in FIG. 6A.

FIG. 7A is a schematic diagram illustrating the transflective display device is in reflective mode.

FIG. 7B is a schematic diagram illustrating timing of the control signals and the data signals for the display panel in FIG. 7A.

FIG. 8 is a schematic diagram showing a mixed frame image including some figures and some letters.

FIG. 9A is a schematic diagram illustrating timing of the control signals and the data signals for the display panel in FIG. 8 according to conventional driving method.

FIG. 9B is a schematic diagram illustrating timing of the control signals and the data signals for the display panel in FIG. 8 according to the concept of the present invention.

FIG. 10A is a schematic diagram illustrating a configuration of a de-multiplexer.

FIG. 10B is a schematic diagram illustrating a configuration of a de-multiplexer.

FIG. 100 is a schematic diagram illustrating timing of the control signals and the data signals for a color display device to display a monochrome frame image.

FIG. 11 is a schematic diagram illustrating another configuration of the de-multiplexer.

FIG. 12A is a schematic diagram illustrating timing of the control signals and the data voltage for the de-multiplexer shown in FIG. 11 when the voltage of data signals remain within the horizontal period.

FIG. 12B is a schematic diagram illustrating timing of the control signals and the data signals for the de-multiplexer shown in FIG. 11 when the voltage of data signals change within the horizontal period.

FIGS. 13A and 13B are schematic diagrams illustrating still another configuration of the de-multiplexer.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

In order to reduce the power consumption of the data driver, switching (turn on and turn off) times of the switches and control signals should be minimized. According to the concept of the present invention, once the data signal from data process portion remains constant in some period, the control signals of the de-multiplexer controller constantly holds voltage level during the same horizontal period. Furthermore, voltage change degree of the data signal is reduced.

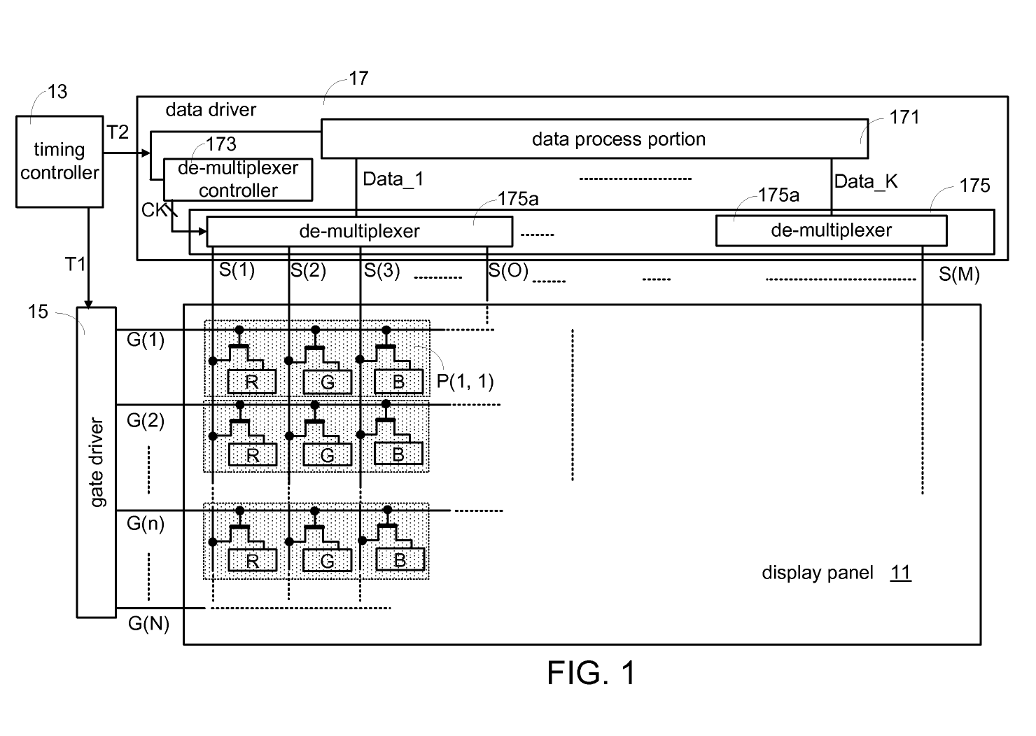

FIG. 1 is a schematic view showing the configuration of a display device. The LCD includes a display panel 11, at least one gate driver 15, at least one data driver 17, and a timing controller 13. Wherein the display panel 11 comprises a plurality of gate lines G(1)˜G(N), a plurality of data lines S(1)˜S(M), a plurality of pixels P, and a plurality of thin film transistor (TFT) switches connected to corresponding gate lines, data lines and sub-pixels for controlling. Each of the pixels P comprises at least two sub-pixels (two gray level sub-pixels), three color sub-pixels (R-G-B), or four color sub-pixels (R-G-B-W).

The timing controller 13 respectively generates and outputs a first set of timing signals (T1) to the gate driver 15 and a second set of timing signals (T2) to the data driver 17. Timing procedure of the gate drivers 15 and data drivers 17 are determined by the timing controller 13. The data driver 17 further includes a data process portion 171, a de-multiplexer controller 173 and a de-multiplexer portion 175. Wherein the de-multiplexer portion 175 comprises a plurality of de-multiplexers (DEMUXes) 175a. The number of de-multiplexer 175a is related to the number of data lines corresponding to the de-multiplexer 175a. For instance, 0 data lines are corresponding to one de-multiplexer 175a, and the number of de-multiplexer 175a is equal to M data lines divided by 0. The number of de-multiplexer (represented as K) is equal to M/O. Wherein K signal lines (Data_1 to Data_K) are respectively disposed between data process portion 171 and de-multiplexer 175a for transmitting data signals.

Hereinafter, variables shown in capital represent amount of different internal items for illustration purpose. Number of de-multiplexers 175a in the de-multiplexer portion 175 is represented as a variable K. Number of signal lines connected between the de-multiplexer 175a and the data process portion 171 is represented as a variable P (P is assumed to be 1 in FIG. 1). Thus, total number of signal lines outputted from the data process portion 171 can be represented as P*K. Number of control signals for a de-multiplexer 175a is represented as a variable O. Accordingly, number of data lines connected to the de-multiplexer 175a, and number of switches in the de-multiplexer 175a can be represented as P*O.

Number of sub-pixels in a row or number of data lines are represented as variable M (M=P*O*K). Number of sub-pixels in a column or number of gate lines are represented as variable N, and so on. These variables (K, O, P, M, N etc.) are positive integers. Among these variables, M and O are multiple of three for a display panel with RGB sub-pixels format, or M and O are multiple of four for a display panel with RGBW sub-pixels format. Furthermore, variables which are lower case denote ordering of a specific item.

The de-multiplexer portion 175 comprises K de-multiplexers 175a. De-multiplexer 175a is respectively electrically connected to the data process portion 171 through P signal lines (P=1 in FIG. 1). The de-multiplexer controller 173 connects to the timing controller 13, the data process portion 171 and the de-multiplexer portion 175. The de-multiplexer controller 173 supplies control signals to the de-multiplexer 175a of the de-multiplexer portion 175 through control lines (CK). Base on the driving of control signals of the de-multiplexer controller 173, each of the K de-multiplexers 175a could supply 0 data signals for served sub-pixels on 0 columns of the display panel 11.

Within the display panel 11, N gate lines G(1), G(2) . . . G(N) are arranged in parallel rows and M data lines S(1), S(2) . . . S(M) are arranged in parallel columns. The display panel 11 includes an array of M*N sub-pixels, and three adjacent sub-pixels respectively with RGB colors represent a pixel P. Pixel P(1, 1) includes a red sub-pixel (R), a green sub-pixel (G), and a blue sub-pixel (B). The resolution of the display panel 11 is (M/3)*N. Transmittance of each sub-pixel depends on the data signal inputted from the data lines.

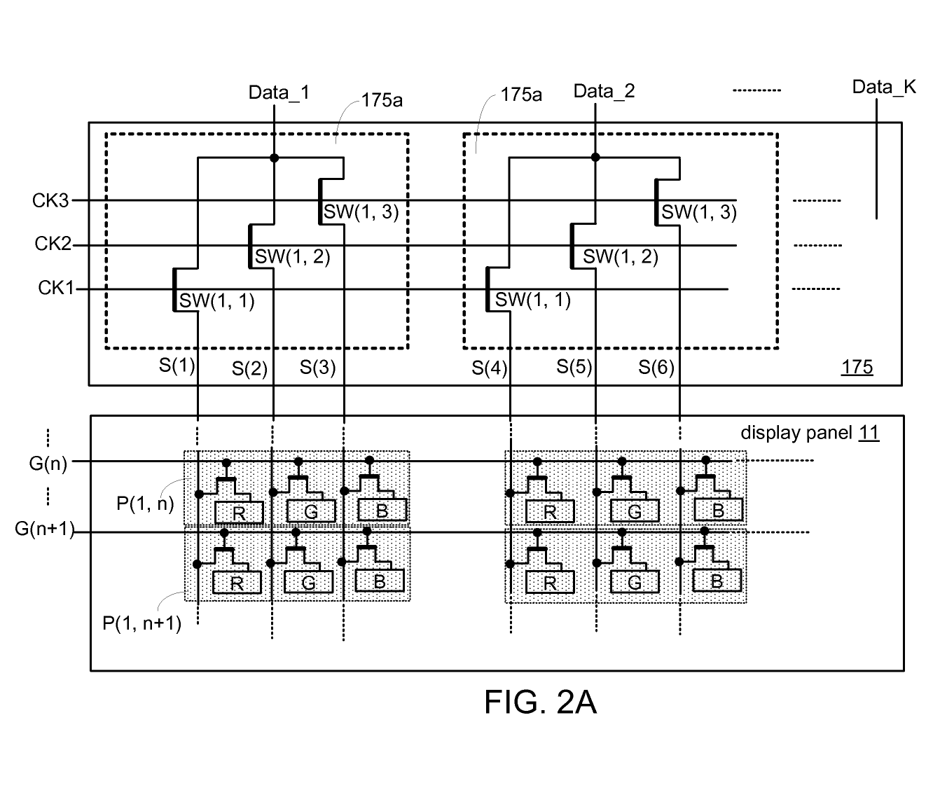

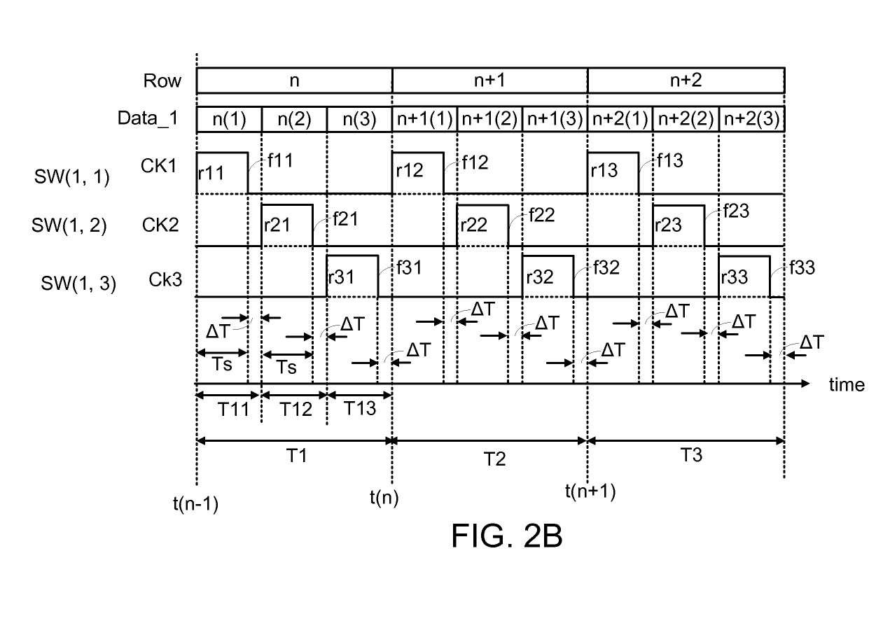

FIG. 2A is a schematic diagram illustrating configuration of a de-multiplexer portion 175 connected to a display panel 11. For the sake of convenience, one de-multiplexer 175a is assumed to be electrically connected to one signal line Data_1, three control lines and control signals CK1˜CK3, and three data lines S1-S3 of display panel 11. De-multiplexer 175a includes three switches SW(1, 1), SW(1, 2), SW(1, 3), which are respectively controlled by the first control line CK1, the second control line CK2, and the third control line CK3. The de-multiplexer 175a sequentially outputs data signals to sub-pixels of the display panel 11 by the driving control of switches and control signals.

FIG. 2B is a schematic diagram illustrating timing of the control signals for the first de-multiplexer shown in FIG. 2A. In some horizontal periods of a frame image, the control signals CK1, CK2, CK3 (voltage) of the control lines are alternately generated to switch on the switches SW(1, 1), SW(1, 2), SW(1, 3) of the de-multiplexer. When the switch SW(1, 1) is turned on in a first sub-period (for example, n(1), n+1(1), n+2(1) etc.) of horizontal period, the data signal (voltage) inputted from the signal lines Data_1 is outputted to the first data line S(1). When the switch SW(1, 2) is turned on in a second sub-period (for example, n(2), n+1(2), n+2(2) etc.) of horizontal period, the data signal (voltage) inputted from the signal line Data_1 is outputted to the second data line S(2). When the switch SW(1, 3) is turned on in a third sub-period (for example, n(3), n+1(3), n+2(3) etc.) of horizontal period, the data signal inputted from the signal line Data_1 is outputted to the third data line S(3). The horizontal period is corresponding to gate lines G(1)˜G(N) driving. For the n-th gate line G(n) and sub-pixels in the n-th row, a corresponding horizontal period represents a scan period of G(n). The scan period of G(n) is followed by another horizontal period corresponding to (n+1)-th gate line G(n+1).

Each de-multiplexer correspondingly provides P*O data signals to sub-pixels row by row. Hereinafter, an n-th horizontal period is corresponding to the duration that de-multiplexer unit outputs data signals for sub-pixels in the n-th row. In addition, the n-th horizontal period is followed by an (n+1)-th horizontal period, and so on.

As shown in FIG. 2B, each of the horizontal periods T1, T2, T3 is further divided into three sub-periods. For example, the n-th horizontal period T1 is divided into three sub-periods T11, T12, T13. These three sub-periods are corresponding to pulses of the three control signals CK1, CK2, CK3. During the sub-period T11, a pulse of the control signal CK1 is generated and sustained until an open slot (AT) before end of the sub-period T11. During the sub-period T12, a pulse of the control signal CK2 is generated and sustained until an open slot (AT) before end of the sub-period T12. During the sub-period T13, a pulse of the control signal CK3 is generated and sustained until an open slot (ΔT) before end of the sub-period T13. Thus, the pulses of the control signals CK1, CK2, CK3 do not overlap with each other during the n-th horizontal period T1. Generations of the pulses of the control signals CK1, CK2, CK3 in the other horizontal periods are similar and not further illustrated to avoid redundancy. The switch turned on and turned off intervals between sub-periods are used to prevent the switches SW(1, 1), SW(1, 2), SW(1, 3) from fetching data signal in improper timing. Timing controls related to the switch turned on and turned off intervals are auxiliary and details of which are neglected in following discussion.

During the first sub-period T11 of the n-th horizontal period T1, the switch SW(1, 1) of de-multiplexer 175a is turned on by the control signal CK1. Meanwhile, the switch SW(1, 1) outputs data signal n(1) to the data line S(1), and gray level of the red sub-pixel in the n-th row (that is, red sub-pixel of the pixel P(1, n)) is accordingly determined by the data signal n(1) during the sub-period T11.

During the second sub-period T12 of the n-th horizontal period T1, the switch SW(1, 2) of de-multiplexer 175a is turned on by the control signal CK2. Meanwhile, the switch SW(1, 2) outputs data signal n(2) to the data line S(2), and gray level of the green sub-pixel in the n-th row (that is, green sub-pixel of the pixel P(1, n)) is accordingly determined by the data signal n(2) during the sub-period T12.

During the third sub-period T13 of the n-th horizontal period T1, the switch SW(1, 3) of de-multiplexer 175a is turned on by the control signal CK3. Meanwhile, the switch SW(1, 3) outputs data signal n(3) to the data line S(3), and gray level of the blue sub-pixel in the n-th row (that is, blue sub-pixel of the pixel P(1, n)) is accordingly determined by the data signal n(3) during the sub-period T13.

Similarly, during the (n+1)-th horizontal period T2, the signal line Data_1 sequentially and alternately outputs data signal n+1(1), n+1(2) and n+1(3) during three sub-periods so that gray level of the R/G/B sub-pixels of the pixel P(1, n+1) are respectively determined by the data signals n+1(1), n+1(2) and n+1(3). Details about how the switches SW(1, 1), SW(1, 2), SW(1, 3) are controlled to fetch data signals from the signal line Data_1 during the (n+2)-th horizontal period can be conducted by analogy and are not reluctantly illustrated.

According to FIG. 2B, the control signal CK1 has to turn on and off three times (r11, f11), (r12, f12), (r13, f13) within a horizontal period, so as to cause power consumption.

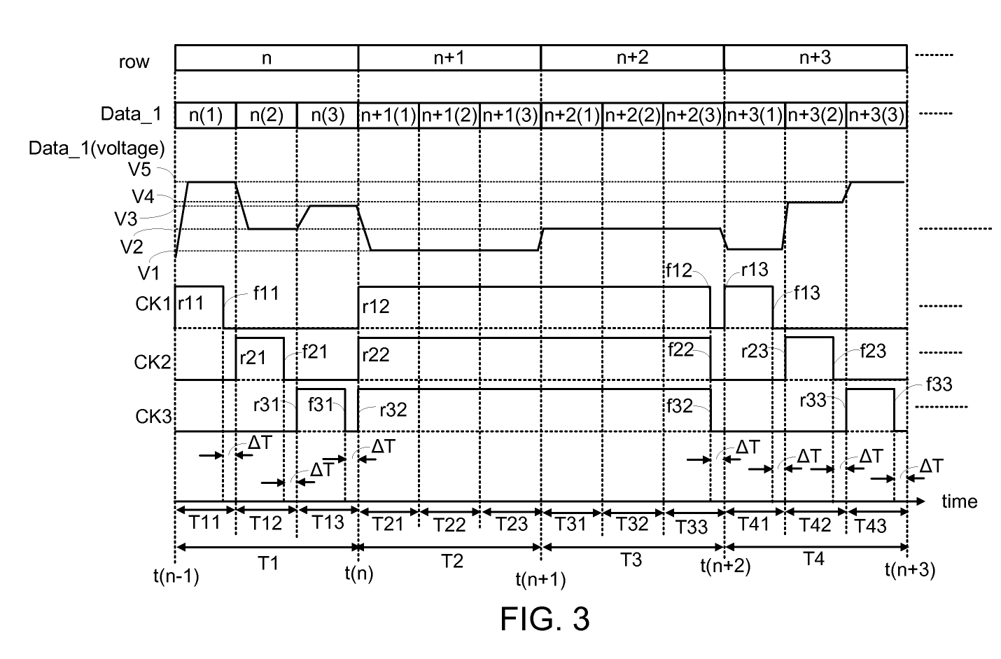

FIG. 3 is a schematic diagram illustrating timing of the control signals for the first de-multiplexer shown in FIG. 2A according to a concept of the present invention. During the horizontal periods T1, T2, T3, T4, data signal (voltage) are generated and outputted by the data process portion. The signal line Data_1 sequentially and respectively outputs data signals to the sub-pixels in the n-th row, the (n+1)-th row, the (n+2)-th row, and the (n+3)-th row.

According to FIG. 3, the n-th horizontal period T1 is between time point t(n−1) and time point t(n), and is divided into three sub-periods T11, T12, T13. The (n+1)-th horizontal period T2 is between time point t(n) and time point t(n+1), and is divided into three sub-periods T21, T22, T23. The (n+2)-th horizontal period T3 is between time point t(n+1) and the time point t(n+2), and is divided into three sub-periods T31, T32, T33. The (n+3)-th horizontal period T4 is between the time point t(n+2), and is divided into three sub-periods T41, T42, T43.

During the n-th horizontal period T1, the data process portion changes voltage level of the data signal outputted to the signal line Data_1. During the sub-period T11, target voltage level of the data signal n(1) is V5. During the sub-period T12, target voltage level of the data signal n(2) is V2. During the sub-period T13, target voltage level of the data signal n(3) is V3. As voltage level of the data signal changes in any of the sub-periods, the de-multiplexer controller alternately (asynchronously) generates control signals CK1, CK2, CK3 as pulses in three sub-periods T11, T12, T13 for controlling the data signal addressing.

The data line S(1) receives the data signal n(1) within the first sub-period T11. The data line S(2) receives the data signal n(2) within the second sub-period T12. The data line S(3) receives the data signal n(3) within the sub-period T13.

During the (n+1)-th horizontal period T2, voltage level of the data signal outputted to the input signal line Data_1 remains as V1. That is, voltage level of the data signal n+1(1) is equal to that of the data signals n+1(2) and n+1(3). According to the embodiment of the present invention, all the control signals CK1, CK2, CK3 are synchronous (in phase) and remain high voltage level (turned on voltage of switches of DEMUX) during the (n+1)-th horizontal period T2. Meanwhile, all the switches SW(1, 1), SW(1, 2), SW(1, 3) remain as turned on due to the high voltage level of the control signals CK1, CK2, CK3. Consequentially, the data lines S(1), S(2), S(3) simultaneously receive the data signal n+1(1)=V1 in the sub-period T21, the data signal n+1(2)=V1 in the sub-period T22, and the data signal n+1(3) during the sub-period T23.

The data lines S(1), S(2), S(3) simultaneously and consistently receive an identical data signal with same voltage level (V1) during the (n+1)-th horizontal period T2. In other words, by synchronously controlling the control signals CK1-CK3, conduction of the switches SW(1, 1), SW(1, 2), SW(1, 3) do not have any terminating or blank period during the (n+1)-th horizontal period T2 as the voltage level of the signal line Data_1 remains constant.

During the (n+2)-th horizontal period T3, the de-multiplexer controller simultaneously (synchronously) and constantly holds the control signals CK1, CK2, CK2 as high voltage level (turned on voltage of switches of DEMUX). Accordingly, all the data lines S(1), S(2), S(3) simultaneously and consistently receives an identical data signal with same voltage level (V2) during the (n+2)-th horizontal period T3. During the (n+3)-th horizontal period T4, the data line S(1), the data line S(2), and the data line S(3) respectively receive the data signal n+3(1) within the sub-period T41, the data signal n+3(2) within the sub-period T42, and the data signal n+3(3) within the sub-period T43.

According to the embodiment of the present invention, when the data signal outputted from the signal line Data_1 changes in any of the three sub-periods in a horizontal period, the de-multiplexer controller alternately generates control signals as pulses. Thus, the voltage level of the signal line Data_1 is time-divided in the n-th horizontal period T1, and the (n+3)-th horizontal period T4. Thus, the control signals CK1, CK2, CK3 are generated in a form of pulse to prevent the switches SW(1, 1), SW(1, 2), SW(1, 3) from conducting incorrect data signal to the data lines S(1), S(2), S(3).

On the other hand, as long as the voltage of the data signal remains constant for a horizontal period, the control signals CK1, CK2, CK3 will remain as high level during the horizontal period. Therefore, for the (n+1)-th horizontal period T2, and the (n+2)-th horizontal period T3, the voltage level of the input signal line Data_1 remains unchanged for the whole horizontal period. In such case, even if the switch SW(1, 1) remains as turn-on during the last two sub-periods, voltage level of the data line S(1) is not affected. In other words, in the (n+1)-th horizontal period T2, and the (n+2)-th horizontal period T3, the gray level of the sub-pixel related to the data line S(1) is not influenced even if the turn-on duration of the switch SW(1, 1) is extended.

According to the present invention, switching times of the control signals CK1, CK2, CK3 can be reduced when voltage level of the data signal remains. The control signal CK1 switches only twice (r11, f11), (r12, f12) during three continuous horizontal periods (T1, T2, T3), so as the control signal CK2 and the control signal CK3. If the number of continuous horizontal periods with the feature that the data signals hold as constant value longer, the power consumption caused by the data driver will decrease more obviously.

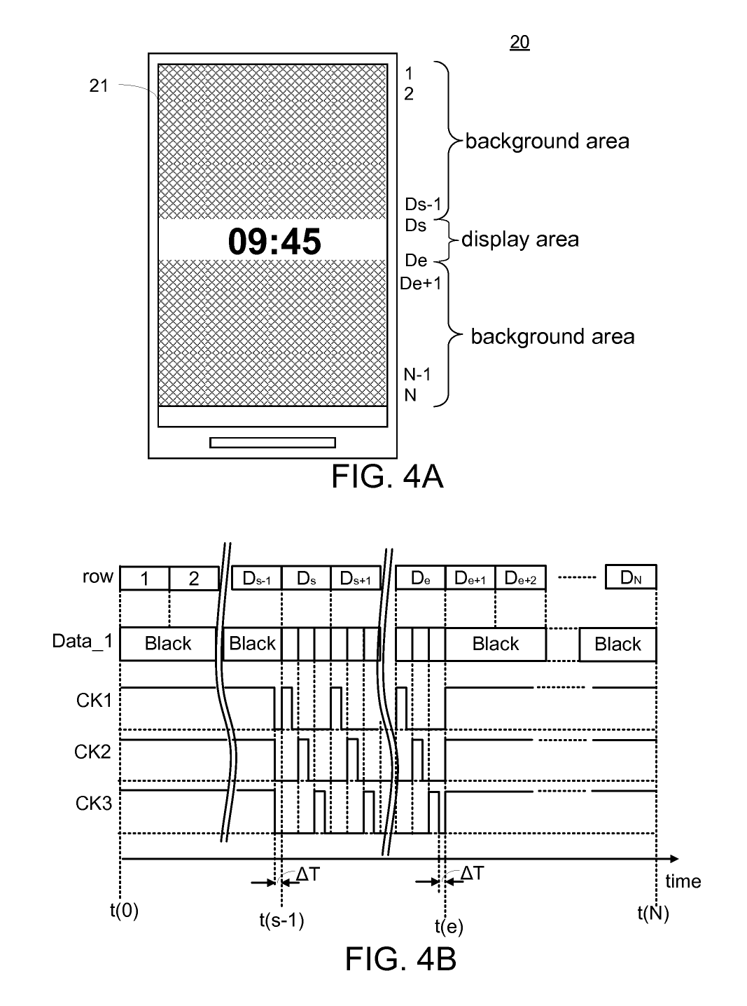

FIG. 4A is a schematic diagram illustrating a portrait type display device 20. The display device 20 is assumed to be in a portrait mode. The display panel 21 (active area) displays a current time (for example, 09:45) in the display area and background color in the background areas. The display area is between the background areas. The display area is assumed to be corresponding to rows from Ds to De; and the background areas are assumed to be corresponding to rows of gate lines and sub-pixels from 1 to Ds−1 and rows from De+1 to N.

For the sub-pixels arranged in the rows from 1 to Ds−1, and the sub-pixels arranged in the rows from De+1 to N, the display panel 21 displays in monochrome (in black, white or gray-level). That is, gray-level of the sub-pixels in these rows are identical, and this implies that the voltage level of all the data lines remain constant for sub-pixels in rows from 1 to Ds−1 and De+1 to N.

FIG. 4B is a schematic diagram illustrating timing of the control signals for the display panel 21 of the display device 20 in FIG. 4A. From time point t(0) to time point t(s−1), the signal line Data_1 continuously and constantly provides data signals representing “black” gray level. Thus, voltage levels of the control signals CK1, CK2, CK3 synchronously remain at high voltage level from the time point t(0) to time point t(s−1). Therefore, according to the present invention, the control signals CK1, CK2, CK3 switch only once between time point t(0) to time point t(s−1). On the other hand, based on a conventional data driver, all the control signals CK1, CK2, CK3 need to switch (Dₛ₋₁) times.

From the time point t(s−1) to time point t(e), the data signal provided by the signal line Data_1 varies. Therefore, the control signals CK1, CK2, CK3 will alternately (asynchronously) switch on the switches SW(1, 1), SW(1, 2), SW(1,3). Therefore, all the control signals CK1, CK2, CK3 switch (De−Ds−1) times between time point t(s−1) to time point t(e).

From time point t(e) to time point t(N), the signal line Data_1 continuously and constantly provides data signal representing “black” gray level. Thus, all the control signals CK1, CK2, CK3 remains at high voltage level synchronously from the time point t(e) to time point t(N). Accordingly, all the control signals CK1, CK2, CK3 switch only once between time point t(e) to time point t(N) according to the present invention. On the other hand, based on a conventional data driver, the control signals CK1, CK2, CK3 need to switch (N−De) times.

According to the embodiment shown in FIGS. 4A and 4B, the switching times of the control signals CK1, CK2, CK3 are proved to be minimized for displaying rows in monochrome.

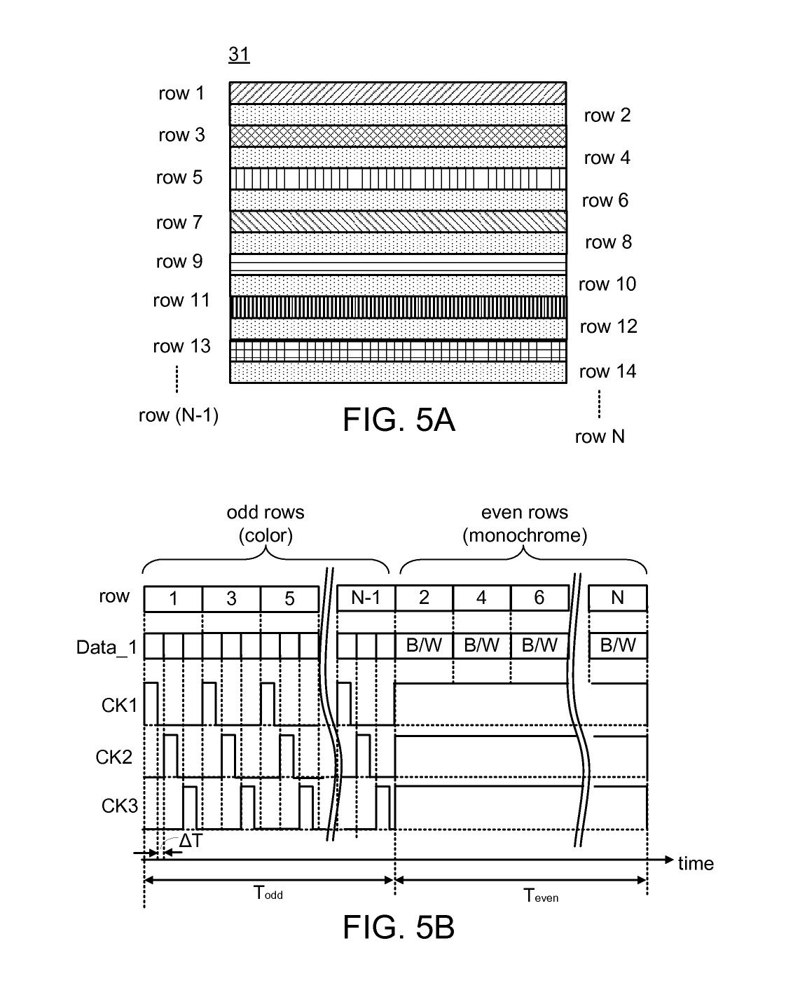

FIG. 5A is a schematic diagram illustrating a display panel 31 for displaying an interlaced frame image. In this case, the odd rows of the frame image are displayed with color normally, and the even rows of the frame image are displayed in monochrome. For the sake of convenience, N is assumed as an even number.

FIG. 5B is a schematic diagram illustrating timing of the control signals and the data signal for the display panel in FIG. 5A. If the display panel displays the sub-pixels in the rows in an ascending order, the control signals CK1, CK2, CK3 will have to switch N times for N rows of sub-pixels.

According to this embodiment, the de-multiplexer firstly outputs data signal to sub-pixels positioned at odd rows of the array and related to odd gate lines. Then, the de-multiplexer units continuously outputs M data signals to the sub-pixels in the even rows. In FIG. 5B, the data driver firstly generates data signals for the sub-pixels in all the odd rows during a display duration T_{odd}. Then, the data driver generates data signals for the sub-pixels in even rows during a display duration Tₑᵥₑₙ.

By centralizing the timing of outputting data signals to monochrome rows, switching occurrences of the control signals CK1, CK2, CK3 can be further reduced. The data signal of the signal line Data_1 is changed in horizontal periods within the display duration Todd. Accordingly, pulses of the control signals CK1, CK2, CK3 are asynchronously generated in horizontal periods within the display duration T_{odd}. On the other hand, the data signal of the input signal line Data1, and the three control signals CK1, CK2, CK3 synchronously remain constant within the display duration Tₑᵥₑₙ.

As shown in FIG. 5B, by changing output order of the data signals, the switching time of the control signals CK1, CK2, CK3 can be reduced to (N/2)+1 times to display an interlaced frame image. In practical application, the pixels in the even rows displaying monochrome can be firstly controlled for display prior the ones in the odd rows.

According to another embodiment, the concept of centralizing the control of the control signals can be applied to a transflective LCD. In transflective LCD, transmissive sub-pixels and reflective sub-pixels are aligned alternatively in rows. The de-multiplexers can keep the switches ON or independently write black data signals to transmissive sub-pixels or reflective sub-pixels.

The transflective LCD may operate in a transmissive mode (transmissive optical performance dominated) or in a reflective mode (reflective optical performance dominated), depending on the luminance of a indoor or outdoor environment. For illustration purpose, the sub-pixels in the odd rows of the transflective LCD are assumed to be transmissive sub-pixels, and the sub-pixels in the even rows of the transflective LCD are assumed to be reflective sub-pixels.

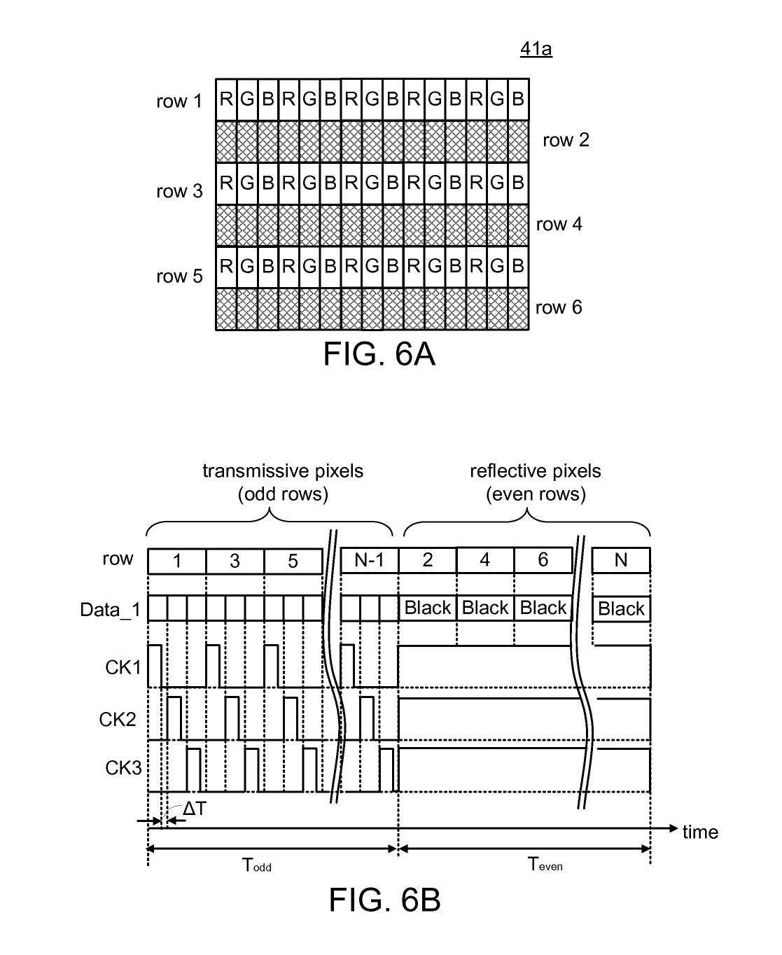

FIG. 6A is a schematic diagram illustrating the transflective LCD is in the transmissive mode. In the transmissive mode, the transmissive sub-pixels in the odd rows are switched on for displaying, and the reflective sub-pixels in the even rows are switched off or switched on to display lower gray level to avoid causing disturbance.

FIG. 6B is a schematic diagram illustrating timing of the control signals and the data signal for the display panel in FIG. 6A. The de-multiplexer remain voltage level of the control signals CK1, CK2, CK3 for the sub-pixels in the even row. Hence, the switches SW(1, 1), SW(1, 2), SW(1, 3) output data signals to the reflective sub-pixels in the even rows to display in “Black” or low gray level. Furthermore, timing of controlling the reflective sub-pixels can be centralized. As shown in FIG. 6B, the de-multiplexer portion firstly outputs M data signals to the sub-pixels in the odd rows (n=1, 3, 5 . . . N−1) during duration T_{odd}, and outputs that to the sub-pixels in the even rows (n=2, 4, 6 . . . N) during duration Tₑᵥₑₙ.

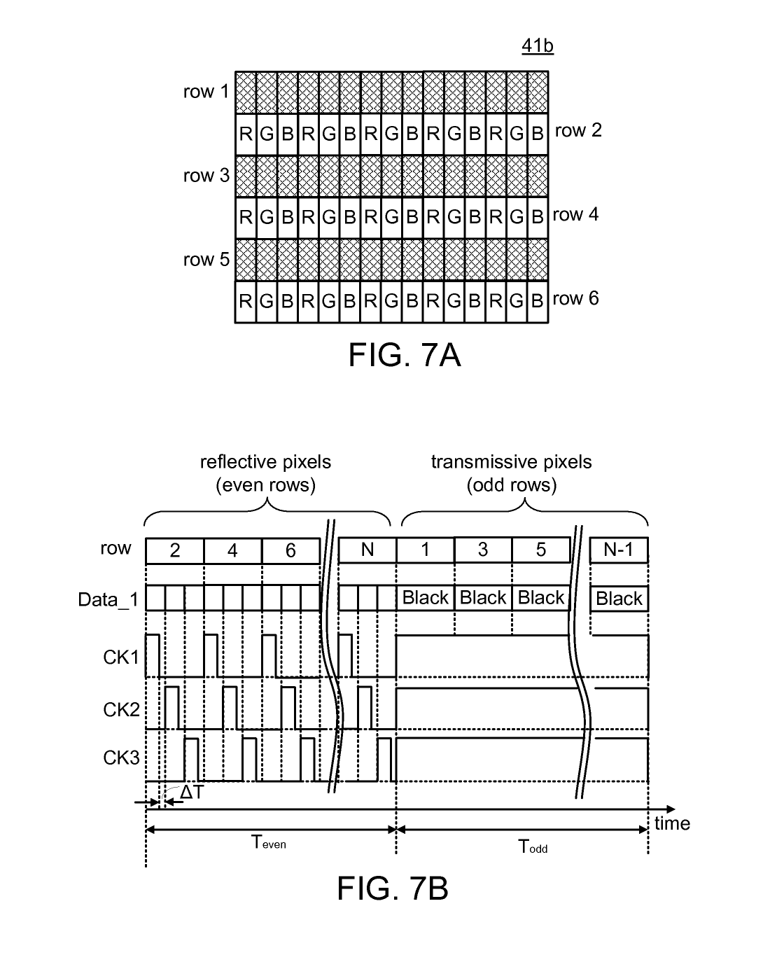

FIG. 7A is a schematic diagram illustrating the transflective LCD is in the reflective mode. In the reflective mode, the transmissive sub-pixels in the odd rows are switched off or switched on to display lower gray level to avoid causing disturbance, and the reflective sub-pixels in the even rows are switched on for displaying.

FIG. 7B is a schematic diagram illustrating timing of the control signals and the data signal for the display panel in FIG. 7A. The de-multiplexer holds voltage level of the control signals CK1, CK2, CK3 for the sub-pixels in the odd row. Hence, the switches SW(1, 1), SW(1, 2), SW(1, 3) output data signals to the transmissive sub-pixels in the odd rows to display in “Black” or low gray level. Furthermore, timing of controlling the transmissive sub-pixels can be centralized. As shown in FIG. 7B, the de-multiplexer firstly outputs M data signals to the sub-pixels in the even rows (n=2, 4, 6 . . . N) during duration Tₑᵥₑₙ, and outputs that to the sub-pixels in the odd rows (n=1, 3, 5 . . . N−1) during duration T_{odd}.

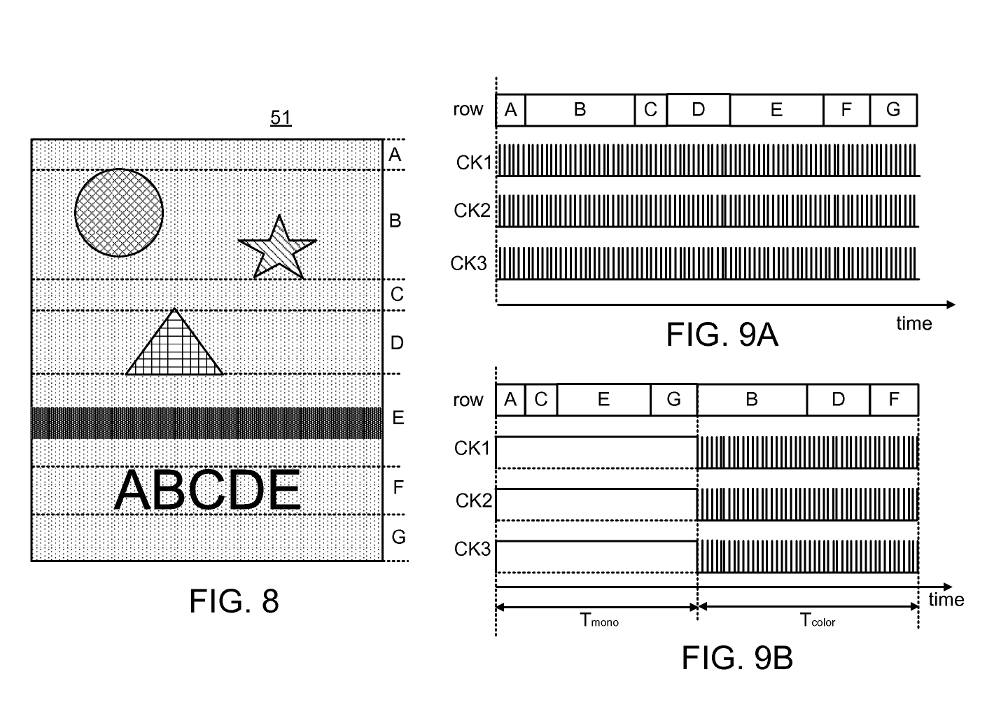

FIG. 8 is a schematic diagram showing a mixed frame image including some figures and some letters. According to the embodiment, an image analyzing software may be used to identify monochrome rows in the frame image 61. For instance, the rows in region A, C, E G will be identified as monochrome (light gray level). In region E, there is a sub-region with darker gray level, but that only affects the voltage level of the data signal in a unit of horizontal period, not the sub-period. Thus, the de-multiplexer controller still synchronously holds the voltage level of the control signals CK1, CK2, CK3 for the sub-region shown in darker gray.

FIG. 9A is a schematic diagram illustrating timing of the control signals and the data signal for the display panel in FIG. 8 according to the conventional display device. As shown in FIG. 9A, the display panel will sequentially displays the frame image in a row-by-row sequence, and the control signals CK1, CK2, CK3 are frequently changed asynchronously.

FIG. 9B is a schematic diagram illustrating timing of the control signals and the data signal for the display panel in FIG. 8 according to the concept of the present invention. As shown in FIG. 9B, the monochrome regions (that is, regions A, C, E, G) are centralized for displaying during a display duration Tₘₒₙₒ. Besides, the color regions (that is, regions B, D, F) are centralized for displaying during another display duration T_{color}. The sequence of the display durations Tₘₒₙₒ and T_{color} can be changed.

Comparing with FIG. 9A, the switching time of the control signals CK1, CK2, CK3 are dramatically reduced in FIG. 9B. Thus, the embodiment is capable of saving power consumption of the data driver, so as the display device.

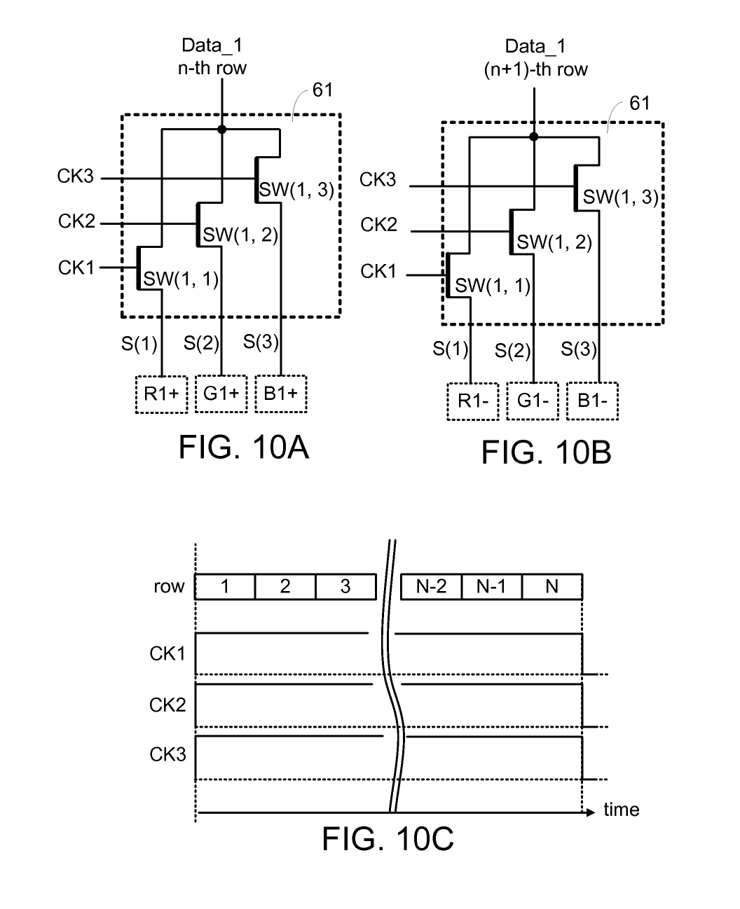

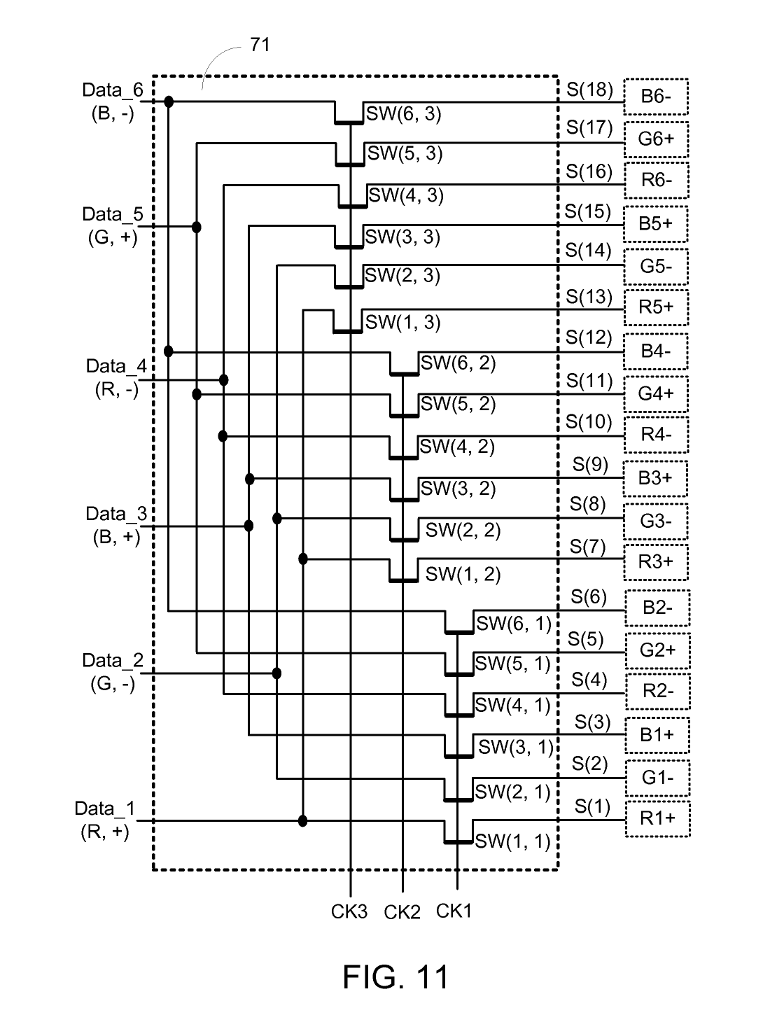

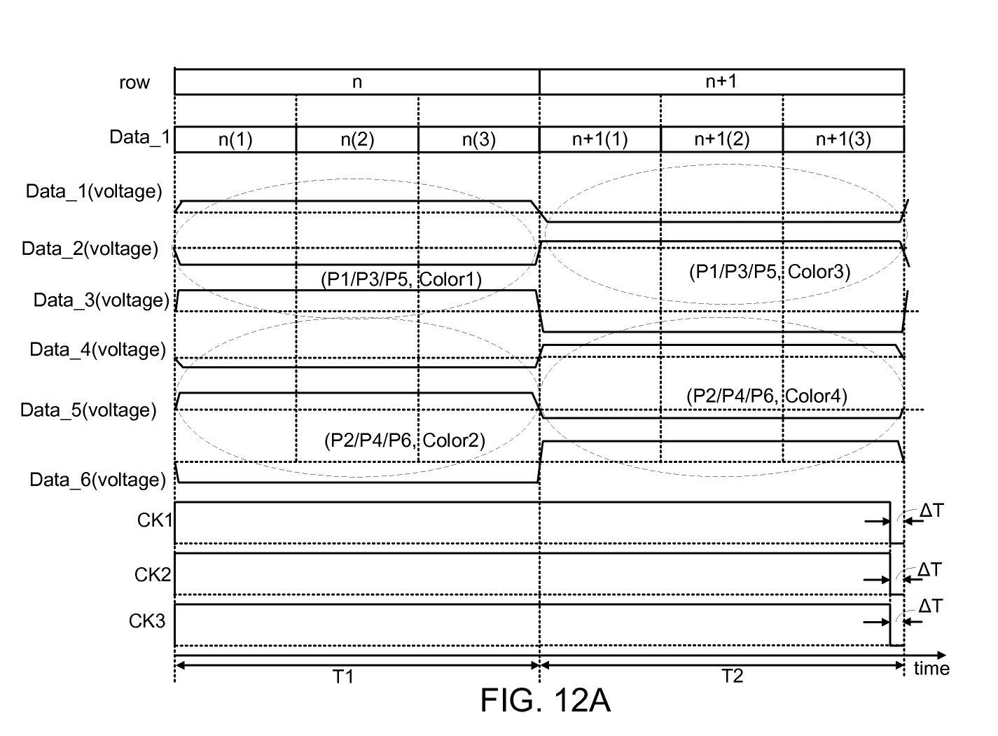

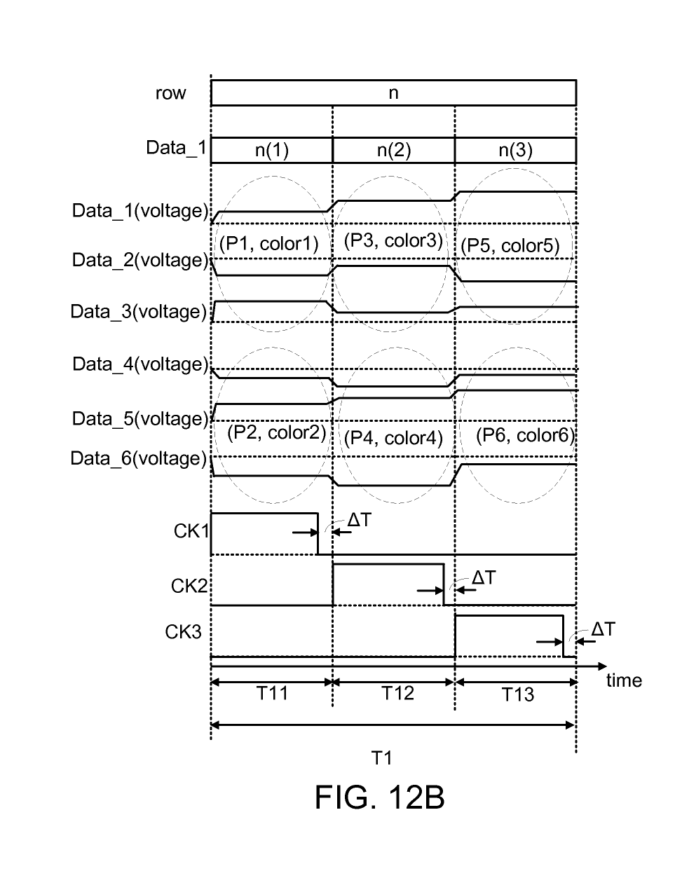

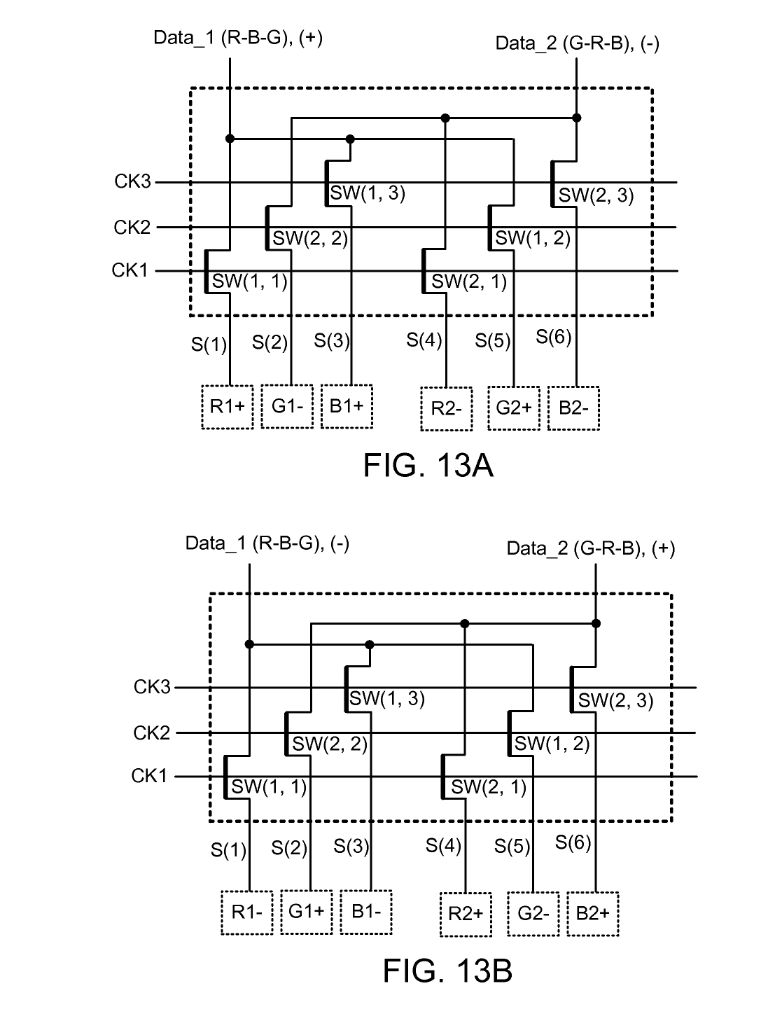

In LCD display device, for avoiding the liquid crystal cells become polarized, the polarities of data signals for sub-pixels must be inversed when the row for displaying changes. Polarities of data signals represent the voltage level compared with common voltage. For example, in FIG. 10A, the polarity of the signal line Data_1 is positive. On the other hand, in FIG. 10B, the polarity of the signal line Data_1 will change to be negative while controlling the sub-pixels at the (n+1)-th row. The three switches SW(1, 1), SW(2, 1), SW(3, 1) are respectively controlled by the three control signals CK1, CK2, CK3.

FIG. 10C is a schematic diagram illustrating timing of the control signals and the data signal for the de-multiplexer shown in FIGS. 10A and 10B. The control signals CK1, CK2, CK3 all remain high level no matter sub-pixels at which rows are displayed. Thus, all the three switches SW(1, 1), SW(2, 1), SW(3, 1) will simultaneously and continuously conduct data signal of the signal line Data_1 to the sub-pixels R1, G1, B1. Since the three switches SW(1, 1), SW(2, 1), SW(3, 1) receive an identical data signal from the signal line Data_1, the voltage level of the data signals S(1), S(2), S(3) are equivalent. By applying such control signals to a color display, the color display can display frame images in monochrome.

FIG. 11 is a schematic diagram illustrating another configuration of the de-multiplexer. In FIG. 11, all the sub-pixels are labeled with numbers representing the order of sub-pixel, color (R/G/B), and polarities (+/−). For example, R1+ representing a data signal with negative voltage level is outputted to the red sub-pixel of the first pixel.

In response to control of the control signals CK1, CK2, CK3, the signal line Data_1 outputs a positive data signal (+) to a first group of switches SW(1, 1), SW(1, 2), SW(1, 3). When voltage level of the control signal CK1 is high, the switch SW(1, 1) is turned on and outputs the positive data signal (+) to the data line S(1). Accordingly, gray level of the red sub-pixel of the first pixel (R1) is determined by the positive data signal (+). When voltage level of the control signal CK2 is high, the switch SW(1, 2) is turned on and outputs the positive data signal (+) to the data line S(7). Accordingly, gray level of the red sub-pixel of the third pixel (R3) is determined by the positive data signal (+). When voltage level of the control signal CK3 is high, the switch SW(1, 3) is turned on and outputs the positive data signal (+) to the data line S(13). Accordingly, gray level of the red sub-pixel of the fifth pixel (R5) is determined by the positive data signal (+).

In response to control of the control signals CK1, CK2, CK3, the signal line Data_2 outputs a negative data signal (−) to a second group of switches SW(2, 1), SW(2, 2), SW(2, 3). When voltage level of the control signal CK1 is high, the switch SW(2, 1) is turned on and outputs the negative data signal (−) to the data line S(2). Accordingly, gray level of the green sub-pixel of the first pixel (G1) is determined by the negative data signal (−). When voltage level of the control signal CK2 is high, the switch SW(2, 2) is turned on and outputs the negative data signal (−) to the data line S(8). Accordingly, gray level of the green sub-pixel of the third pixel (G3) is determined by the negative data signal (−). When voltage level of the control signal CK3 is high, the switch SW(2, 3) is turned on and outputs the negative data signal (−) to the data line S(14). Accordingly, gray level of the green sub-pixel of the fifth pixel (G5) is determined by the negative data signal (−).

In response to control of the control signals CK1, CK2, CK3, the signal line Data_3 outputs a positive data signal (+) to a third group of switches SW(3, 1), SW(3, 2), SW(3, 3). When voltage level of the control signal CK1 is high, the switch SW(3, 1) is turned on and outputs the positive data signal (+) to the data line S(3). Accordingly, grey level of the blue sub-pixel of the first pixel (B1) is determined by the positive data signal (+). When voltage level of the control signal CK2 is high, the switch SW(3, 2) is turned on and outputs the positive data signal (+) to the data line S(9). Accordingly, gray level of the blue sub-pixel of the third pixel (B3) is determined by the positive data signal (+). When voltage level of the control signal CK3 is high, the switch SW(3, 3) is turned on and outputs the positive data signal (+) to the data line S(15). Accordingly, gray level of the blue sub-pixel of the fifth pixel (B5) is determined by the positive data signal (+).

In response to control of the control signals CK1, CK2, CK3, the signal line Data_4 outputs a negative data signal (−) to a fourth group of switches SW(4, 1), SW(4, 2), SW(4, 3). When voltage level of the control signal CK1 is high, the switch SW(4, 1) is turned on and outputs the negative data signal (−) to the data line S(4). Accordingly, gray level of the red sub-pixel of the second pixel (R2) is determined by the negative data signal (−). When voltage level of the control signal CK2 is high, the switch SW(4, 2) is turned on and outputs the negative data signal (−) to the data line S(10). Accordingly, gray level of the red sub-pixel of the fourth pixel (R4) is determined by the negative data signal (−). When voltage level of the control signal CK3 is high, the switch SW(4, 3) is turned on and outputs the negative data signal (−) to the data line S(16). Accordingly, gray level of the red sub-pixel of the sixth pixel (R6) is determined by the negative data signal (−).

In response to control of the control signals CK1, CK2, CK3, the signal line Data_5 outputs a positive data signal (+) to a fifth group of switches SW(5, 1), SW(5, 2), SW(5, 3). When voltage level of the control signal CK1 is high, the switch SW(5, 1) is turned on and outputs the positive data signal (+) to the data line S(5). Accordingly, gray level of the green sub-pixel of the second pixel (G2) is determined by the positive data signal (+). When voltage level of the control signal CK2 is high, the switch SW(5, 2) is turned on and outputs the positive data signal (+) to the data line S(11). Accordingly, gray level of the green sub-pixel of the fourth pixel (G4) is determined by the positive data signal (+). When voltage level of the control signal CK3 is high, the switch SW(5, 3) is turned on and outputs the positive data signal (+) to the data line S(17). Accordingly, gray level of the green sub-pixel of the sixth pixel (G6) is determined by the positive data signal (+).

In response to control of the control signals CK1, CK2, CK3, the signal line Data_6 outputs a negative data signal (−) to a sixth group of switches SW(6, 1), SW(6, 2), SW(6, 3). When voltage level of the control signal CK1 is high, the switch SW(6, 1) is turned on and outputs the negative voltage (−) to the data line S(6). Accordingly, gray level of the blue sub-pixel of the second pixel (B2) is determined by the negative data signal (−). When voltage level of the control signal CK2 is high, the switch SW(6, 2) is turned on and outputs the positive data signal (+) to the data line S(12). Accordingly, gray level of the blue sub-pixel of the fourth pixel (B4) is determined by the negative data signal (−). When voltage level of the control signal CK3 is high, the switch SW(6, 3) is turned on and outputs the negative data signal (−) to the data line S(18). Accordingly, gray level of the blue sub-pixel of the sixth pixel (B6) is determined by the negative data signal (−).

Therefore, for the pixels in the n-th row, relationships between color of the pixels and the signal lines are listed as following.

The color of the first pixel (color1) is together determined by the red sub-pixel (R1) conducting the positive data signal voltage (+) from the signal line Data_1, the green sub-pixel (G1) conducting the negative data signal voltage (−) from the signal line Data_2, and the blue sub-pixel (B1) conducting the positive data signal voltage (+) from the signal line Data_3.

The color of the second pixel (color2) is together determined by the red sub-pixel (R2) conducting the negative data signal voltage (−) from the signal line Data_4, the green sub-pixel (G2) conducting the positive data signal voltage (+) from the signal line Data_5, and the blue sub-pixel (B2) conducting the negative data signal voltage (−) from the signal line Data_6.

The color of the third pixel (color3) is together determined by the red sub-pixel (R3) conducting the positive data signal voltage (+) from the signal line Data_1, the green sub-pixel (G3) conducting the negative data signal voltage (−) from the signal line Data_2, and the blue sub-pixel (B3) conducting the positive data signal voltage (+) from the signal line Data_3.

The color of the fourth pixel (color4) is together determined by the red sub-pixel (R4) conducting the negative data signal voltage (−) from the signal line Data_4, the green sub-pixel (G4) conducting the positive data signal voltage (+) from the signal line Data_5, and the blue sub-pixel (B4) conducting the negative data signal voltage (−) from the signal line Data_6.

The color of the fifth pixel (color5) is together determined by the red sub-pixel (R5) conducting the positive data signal voltage (+) from the signal line Data_1, the green sub-pixel (G5) conducting the negative data signal voltage (−) from the signal line Data_2, and the blue sub-pixel (B5) conducting the positive data signal voltage (+) from the signal line Data_3.

The color of the sixth pixel (color6) is together determined by the red sub-pixel (R6) conducting the negative data signal voltage (−) from the signal line Data_4, the green sub-pixel (G6) conducting the positive data signal voltage (+) from the signal line Data_5, and the blue sub-pixel (B6) conducting the negative data signal voltage (−) from the signal line Data_6.

For the de-multiplexer with configuration of FIG. 11, colors of the pixels are determined by R/G/B sub-pixels with various gray levels (brightness). Therefore, a display device with the de-multiplexer as shown in FIG. 11 can display various color in standby mode.

FIG. 12A is a schematic diagram illustrating timing of the control signals and the data signal for the de-multiplexer shown in FIG. 11 when the voltage of data signals remain constant within the horizontal period.

For the pixels in the n-th row, color of the first pixel (color1), color of the third pixel (color3), and color of the fifth pixel (color5) are determined by the data signal of the signal lines Data_1, Data_2, Data_3. Also, color of the second pixel (color2), color of the fourth pixel (color4) and color of the sixth pixel (color6) are determined by the data signal of the even signal lines Data_2, Data_4, Data_6. For the pixels in the (n+1)-th row, the relationships between the color of the pixels and the signal lines are not changed. That is, color of the odd pixels (P1, P3, P5) are always determined by the signal lines Data_1, Data_2, Data_3, and color of even pixels (P2, P4, P6) are always determined by the signal lines Data_4, Data_5, Data_6.

Difference of the signal lines between the n-th row and the (n+1)-th row is, the polarities of the signal lines are inversed. Therefore, the signal lines with positive voltage level in the n-th row (that is, Data_1, Data_3, Data_5) will change to negative voltage level in the (n+1)-th row, and vice versa.

Furthermore, in a case of representing an identical color for the pixels in the same row, data signal of the signal lines Data_4, Data_5, Data_6 are opposite to that of the signal lines Data_1, Data_2, Data_3. For example, voltage of the signal line Data_4 is −2V if the signal line Data_1 is 2V, and so forth.

In FIG. 12A, the dotted circle at the upper-left corner represents color of the first pixel (P1), the third pixel (P3) and the fifth pixel (P5) in the n-th row, that is, Color 1. Color 1 is determined by the data signal of Data_1, Data_2, Data_3. The dotted circle at the lower-left corner represents color of the second pixel (P2), the fourth pixel (P4) and the sixth pixel (P6) in the n-th row, that is, Color 2. Color 2 is determined by the data signal of Data_4, Data_5, Data_6. It should be noted that the color of the odd pixels in the n-th row (Color1) and the color of the even pixels in the n-th row (Color2) are identical.

In FIG. 12A, the dotted circle at the upper-right corner represents color of the first pixel (P1), the third pixel (P3) and the fifth pixel (P5) in the (n+1)-th row, that is, Color 3. Color 3 is determined by the data signal of Data_1, Data_2, Data_3. The dotted circle at the lower-right corner represents color of the second pixel (P2), the fourth pixel (P4) and the sixth pixel (P6) in the (n+1)-th row, that is, Color 4. Color 4 is determined by the data signal of Data_4, Data_5, Data_6. It should be noted that the color of the odd pixels in the (n+1)-th row (Color3) and the color of the even pixels in the (n+1)-th row (Color4) are identical.

FIG. 12B is a schematic diagram illustrating timing of the control signals and the data signal for the de-multiplexer shown in FIG. 11 when the voltage of data signals change within the horizontal period. The configuration of the de-multiplexer as shown in FIG. 11 can further save power consumption by lowering voltage variance of the data signals. As shown in FIG. 12B, the n-th horizontal period T1 is divided into three sub-periods T11, T12, T13.

During the sub-period T11, the control signal CK1 generates a pulse so that switches SW(1, 1), SW(2, 1), SW(3, 1), SW(4, 1), SW(5, 1), SW(6, 1) are switched on. Accordingly, data lines corresponding to the first pixel S(1), S(2), S(3), and data lines corresponding to the second pixel S(4), S(5), S(6) will transmit data signal s. Therefore, brightness of the R, G, B sub-pixels of the first pixel are respectively determined by the data signals of the signal lines Data_1, Data_2, Data_3 during sub-period T11, and color of the first pixel P1 (that is, color 1) is determined accordingly. Similarly, gray level of the R, G, B sub-pixels of the second pixel are respectively determined by the data signals of the signal lines Data_4, Data_5, Data_6 during the sub-period T11, and color of the second pixel P2 (that is, color 2) is determined accordingly.

During the sub-period T12, the control signal CK2 generates a pulse so that switches SW(1, 2), SW(2, 2), SW(3, 2), SW(4, 2), SW(5, 2), SW(6, 2) are switched on. Accordingly, data lines corresponding to the third pixel S(7), S(8), S(9), and data lines corresponding to the fourth pixel S(10), S(11), S(12) will transmit data signal s. Therefore, brightness of the R, G, B sub-pixels of the third pixel P3 are respectively determined by the data signals of the signal lines Data_1, Data_2, Data_3 during sub-period T12, and color of the third pixel P3 (that is, color 3) is determined accordingly. Similarly, gray level of the R, G, B sub-pixels of the fourth pixel P4 are respectively determined by the data voltages of the signal lines Data_4, Data_5, Data_6 during the sub-period T12, and color of the fourth pixel P4 (that is, color 4) is determined accordingly.

During the sub-period T13, the control signal CK1 generates a pulse so that switches SW(1, 3), SW(2, 3), SW(3, 3), SW(4, 3), SW(5, 3), SW(6, 3) are switched on. Accordingly, data lines corresponding to the fifth pixel S(13), S(14), S(15), and data lines corresponding to the sixth pixel S(16), S(17), S(18) will transmit data signal s. Therefore, gray level of the R, G, B sub-pixels of the fifth pixel P5 are respectively determined by the data signals of the signal lines Data_1, Data_2, Data_3 during sub-period T13, and color of the fifth pixel P5 (that is, color 5) is determined accordingly. Similarly, gray level of the R, G, B sub-pixels of the second pixel are respectively determined by the data voltages of the signal lines Data_4, Data_5, Data_6 during the sub-period T13, and color of the sixth pixel P6 (that is, color 6) is determined accordingly.

FIGS. 13A and 13B are schematic diagrams illustrating still another configuration of the de-multiplexer. FIG. 13A represents polarities of signal lines in the n-th horizontal period, and FIG. 13B represents polarities of signal lines in the (n+1)-th horizontal period.

During the n-th horizontal period, the signal line Data_1 transmits only positive data signal voltages (+) to the data lines S(1), S(3), S(5), and the signal line Data_2 transmits only negative data voltages (−) to the data lines S(2), S(4), S(6). Therefore, during the n-th horizontal period, the voltage of the signal line Data_1 is always positive, and that of the signal line Data_2 is always negative. That is to say, even if the voltage level of the signal lines Data_1, Data_2 change in every sub-period, their polarities remain consistent. Consequentially, voltage variance of the data signals corresponding to the signal lines Data_1, Data_2 are minimized during the n-th horizontal period.

During the (n+1)-th horizontal period, the signal line Data_1 transmits only negative data signal voltages (−) to the data lines S(1), S(3), S(5), and the signal line Data_2 transmits only positive data voltages (+) to the data lines S(2), S(4), S(6). Therefore, during the (n+1)-th horizontal period, the voltage of the signal line Data_1 is always negative, and that of the signal line Data_2 is always positive. That is to say, even if the voltage level of the signal lines Data_1, Data_2 change in every sub-period, their polarities remain consistent. Consequentially, voltage variance of the data signals corresponding to the signal lines Data_1, Data_2 are minimized during the (n+1)-th horizontal period.

In another embodiment of present invention, using the circuits in FIGS. 10A, 10B, 11, 13A, and 13B, the polarities of data signals outputted by the signal lines (Data) and that of the control signals outputted by the control lines (CK) could be changed for column inversion, dot inversion, or N-dot inversion.

The de-multiplexer can be integrated in the LCD panel or OLED panel which uses TFT, the active layer of TFT for example, amorphous silicon (a-Si), low temperature polycrystalline silicon (LTPS) TFT technology or transparent oxide semiconductor (TOS), for example, indium gallium zinc oxide (IGZO). Besides, because the functions provided by the data driver in the display device having RGBW or RGB sub-pixel format are similar, the above embodiments can be easily modified and applied to different types of display devices.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A display device, comprising:
a display panel, comprising a plurality of gate lines, a plurality of data lines, and a plurality of sub-pixels;
a gate driver, connected to the gate lines; and
a data driver, connected to the data lines, comprising:
a de-multiplexer controller, for outputting a plurality of control signals to a plurality of control lines;
a data process portion, for outputting a plurality of data signals to a plurality of signal lines; and
a first de-multiplexer comprising a plurality of switches, connected to the de-multiplexer controller through the control lines, connected to the data process portion through at least one of the signal lines, and connected to the sub-pixels through the data lines,
wherein the switches of the first de-multiplexer keep turned on within a first horizontal period.

2. The display device according to claim 1, wherein the control signals for the first de-multiplexer synchronously keep the switches of the first de-multiplexer turned on or turned off within the first horizontal period.

3. The display device according to claim 1, wherein the control signals for the first de-multiplexer substantially keep the same voltage level within the first horizontal period.

4. The display device according to claim 1, wherein the sub-pixels in a first row and corresponding to the first de-multiplexer substantially keep the data signals as a first voltage level within the first horizontal period.

5. The display device according to claim 4, wherein the sub-pixels in a second row and corresponding to the first de-multiplexer substantially keep the data signals as a second voltage level within a second horizontal period adjacent to the first horizontal period, and the first voltage level and the second voltage level are different.

6. The display device according to claim 5, wherein the first voltage level and the second voltage level have the same polarity with respect to a common voltage level.

7. The display device according to claim 5, wherein the first voltage level and the second voltage level have opposite polarity with respect to a common voltage level.

8. The display device according to claim 4, wherein the sub-pixels in the first row and corresponding to a second de-multiplexer adjacent to the first de-multiplexer substantially keep the data signals as a third voltage level within the first horizontal period, and the first voltage level and the third voltage level have opposite polarity with respect to a common voltage level.

9. The display device according to claim 8, wherein the sub-pixels in the second row corresponding to the second de-multiplexer substantially keep the data signals as a fourth voltage level within a second horizontal period adjacent to the first horizontal period, and the third voltage level and the fourth voltage level are different

10. The display device according to claim 9, wherein the third voltage level and the fourth voltage level have the same polarity with respect to the common voltage level.

11. The display device according to claim 9, wherein the third voltage level and the fourth voltage level have opposite polarity with respect to the common voltage level.

12. The display device according to claim 8, wherein the sub-pixels in the first row corresponding to the first de-multiplexer are interlaced with the sub-pixels in the first row corresponding to the second de-multiplexer.

13. The display device according to claim 12, wherein two adjacent sub-pixels are corresponding to different polarity.

14. The display device according to claim 1, wherein the control signals for the first de-multiplexer are asynchronous within a third horizontal period adjacent to the first horizontal period.

15. The display device according to claim 14, wherein the control signals are separated.

16. The display device according to claim 1, wherein the number of the control lines is equal to the number of the data lines corresponding to the first de-multiplexer.

17. The display device according to claim 1, wherein the sub-pixels comprise transmissive type sub-pixels and reflective type sub-pixels, wherein the transmissive type sub-pixels form rows, and the reflective type sub-pixels form rows therebetween.

18. The display device according to claim 17, wherein the control signals for the reflective type sub-pixels of first de-multiplexer keep substantially the same voltage level within the first horizontal period in transmissive mode.

19. The display device according to claim 17, wherein the control signals for the transmissive type sub-pixels of first de-multiplexer substantially keep the same voltage level within the first horizontal period in reflective mode.

20. A method for driving a display device, the display device comprising:
a display panel, comprising a plurality of gate lines, a plurality of data lines, and a plurality of sub-pixels;
a gate driver, connected to the gate lines; and
a data driver, connected to the data lines, comprising:
a de-multiplexer controller, for outputting a plurality of control signals to a plurality of control lines;
a data process portion, for outputting a plurality of data signals to a plurality of signal lines; and
a first de-multiplexer comprising a plurality of switches, connected to the de-multiplexer controller through the control lines, connected to the data process portion through at least one of the signal lines, and connected to the sub-pixels through the data lines,
wherein the switches of the first de-multiplexer keep turned on within a first horizontal period.
